(19) United States
(12) Patent Application Publication
(10) Pub. No.: US 2022/0168078 A1
(43) Pub. Date: Jun. 2, 2022

(54) DIGITAL DENTAL ARCH DATABASE

(71) Applicant: Merz Dental GmbH, Luetjenburg (DE)

(72) Inventors: Friedhelm Klingenburg, Molfsee (DE); Olaf Klewer, Aachen (DE); Frank POERSCHKE, Becheln (DE)

(21) Appl. No.: 17/425,998

(22) PCT Filed: Jan. 29, 2020
(86) PCT No.: PCT/EP2020/052172

§ 371 Date: Jul. 27, 2021

(30) Foreign Application Priority Data
Jan. 29, 2019 (DE) 10 2019 201 115.2

(51) Int. Cl. A61C 13/01; A61C 13/00; A61C 9/00; A61C 19/05; B33Y 50/00; B33Y 80/00; B29C 64/386

(52) U.S. Cl. CPC A61C 13/01; A61C 13/0004; A61C 13/0019; A61C 9/004; B29L 2031/7536; A61C 13/0022; B33Y 50/00; B33Y 80/00; B29C 64/386; A61C 19/05

(57) ABSTRACT

The invention relates to a method for producing a denture, characterized by a) providing a predefined dental arch database, the dental arch database having data on maxilla and mandible arches in occlusion; b) generating the denture on the basis of the dental arch data on the maxilla and mandible arches in occlusion.

### CROSS REFERENCE OF RELATED APPLICATIONS

This application is a U.S. National Phase application under 35 U.S.C. § 371 of International Patent Application No. PCT/EP2020/052172, filed on Jan. 29, 2020, which claims the priority of German Patent Application No. 102019201115.2, filed on Jan. 29, 2019, the disclosure of which is incorporated herein by reference in its entirety.

The present invention relates to a method for producing a denture and a workpiece for producing a denture on the basis of a digital dental arch database and the use thereof.

Presently, in a majority of cases a denture is produced with the aid of computer-assisted technologies. For example, using a computer-aided design (CAD)/computer aided manufacturing (CAM) method. First the mouth situation is scanned and acquired using an intraoral scanner or an intraoral camera, whereby the conventional taking of an impression is dispensed with. The acquired data are transferred to the CAD software and stored. The denture is designed in the CAD software on the basis of the now provided data of the mouth situation of the patient and produced by a CAM method. For the design of the denture, typically virtual teeth are stored in various sizes and colors in the CAD software. The matching shape and color for the denture can thus be selected on the basis of the ascertained data of the mouth situation. Both individual teeth and also blocks of teeth, for example one block for the posterior teeth, which consists of multiple teeth, can be selected. This method can be used both for individual restorations and also for total or partial prostheses.

Alternatively, a conventional impression and occlusal registration can be carried out by manufacturing plaster models, which are then digitized and designed and produced in a computer-assisted manner.

However, the disadvantage in the conventional method is that after the production of the denture, it is necessary to adapt and position the occlusion by means of an articulator (chewing simulator). The articulator is a device in which the previously manufactured plaster models of the two jaws are installed in occlusion, that is to say in a bite. In this way, the situation of the natural jaw is displaced to an external model, whereby it is made possible to simulate the movements of the jaws in relation to one another outside the mouth of the patient. In addition to conventional articulators, there are also “virtual articulators”. In this case, the digitally created models are used in the virtual articulator. The simulation of the chewing movement by means of an articulator is an additional step, which also involves multiple sessions for the fitting of the denture, which is time-consuming above all both for the technicians and for the patients.

It is therefore the object of the present invention to provide a method for producing a denture and a workpiece for producing a denture which avoid the disadvantages of the prior art. Furthermore, it is the object of the present invention to reduce the work steps and sessions for the individual fitting of the denture to the patient and to improve the comfort of the patient.

According to the invention, to achieve the object it is proposed that a method for producing a denture is provided, in which a predefined digital dental arch database is already provided, wherein the dental arch database has data of maxilla and mandible dental arches already in occlusion. In these terms, the workpiece to be milled is also milled on the basis of the digital data having data of dental arches in occlusion. Therefore, the denture is generated on the basis of the digital data of maxilla and mandible dental arches in occlusion.

Using this measure according to the application, by means of a completely digital workflow, the patient care is reduced to a minimum number of sessions. In this way, the sequence of the work steps is compressed in its complexity to a minimum and the communication exchange between the dentist and the dental technician is reduced to the essentials. The comfort of the patient is thus also improved.

The use of conventional methods such as impression by means of silicone material, production of manual provisional crown and bridge restorations, and multiple fittings to the patient is thus dispensed with. The comfort of the patient is thereby also significantly improved.

The design and production of the denture can be carried out both completely digitally and also in a combination of digital and analog. The restoration can be created between digital and digitally-assisted at any time and as needed and desired by file splitting of the digital data sets of dental arches. A virtual data set can be divided, for example, into two different parts, framework and veneer, via file splitting.

Further advantageous embodiments of the present invention are the subject matter of the dependent claims.

The data of maxilla and mandible dental arches in occlusion are established in a situation-related position. The situation-related position is predefined. The predefined situation-related position is provided by the predefined data of maxilla and mandible dental arches in occlusion. A digital design and a manufacture by means of subtractive and/or additive production methods of a restoration is carried out by the predefined situation-related position.

It is made possible for the user by the predefined digital occlusal position of the data of dental arches of the maxilla and mandible to first digitally design a corresponding restoration without additional functional aids such as articulators and then manufacture it later accordingly by means of subtractive or additive production methods. The subtractive manufacturing methods include grinding, milling, and turning. High-precision restorations can thus be manufactured from greatly varying materials by progressive perfecting. Restorations are built up layer by layer using the additive manufacturing methods. The design can thus be implemented precisely and without pores and complex finishing work can be omitted.

Because of the proposed position and the existing situation relation, the system also offers the option of individually adapting individual teeth from the dental arch database without losing the situation relation and the defined occlusion position.

One or more implant connecting elements can also be digitally positioned and designed in the maxilla and/or mandible on the basis of the predefined data of maxilla and mandible dental arches in occlusion.

The positioning and the selection of the implant connecting elements is carried out in the CAD software. The denture is thereupon produced with recesses for the implant connecting elements.

The tooth shape and/or tooth size and/or tooth color and/or tooth arch width of the predefined digital data of maxilla and mandible dental arches in occlusion can be adapted to scanned data of a mouth situation of a patient. The adaptation is carried out in the CAD software.

By way of the above-described method, a large number of standardized and/or also individualized designs can be generated precisely and efficiently for trays/impression trays and/or prostheses and/or immediate prostheses and/or interim prostheses and/or partial, total, and hybrid prostheses with any form of the secondary and tertiary designs, and/or drilling templates with and without predefined dental arches, and/or orthodontic designs, such as clamps, and aesthetic applications in additive and/or also subtractive production methods.

Using corresponding impression processes, for example an impression by the Baltic Denture System®, wherein the impression, occlusal registration, and transfer, for example, into a dental practice are designed efficiently and the items of information are transferred to the laboratory. However, any type of denture can also be created efficiently and precisely using other known and existing methods on the basis of the predetermined positioning and the situation relation of the maxilla to the mandible, wherein the jaws can also consist of remaining teeth and tooth situations to be obtained. Independently of the type of the structures—whether implants (individual or peg-supported implants), attachments, hybrid designs, and further known structures.

The method is system independent, i.e., applicable independently of the restoration and of the materials used.

The digitized data of dental arches in occlusion thus represent the foundation for a digital design and material-independent further processing to form a denture.

The data of dental arches in occlusion are provided as a digital dental arch database in corresponding software.

The workpiece/the milling blank is ultimately a result of the digital dental arch database with a directly connected prosthesis base.

The greatest possible variety of manufacturing is provided by the dental arch database in occlusion by backward planning/engineering or also reverse planning/engineering.

Backward planning is an optimum implant prosthetic technology, wherein planning is made backward to the implant supply from the ideal implant denture. That is to say, in backward planning, the denture determines the position of the tooth implants. Information about the condition of teeth, bones, and soft tissue are obtained on the basis of models of the teeth of maxilla and mandible. By means of computer-assisted 3D implant planning, the dentist can plan the suitable implant number, the ideal implant positions, their length, alignment, and drilling depth, and also measures for building up soft tissue or bone tissue. The dental technician plans the ideal functional tooth position and tooth aesthetics. The original healthy state of teeth and gums in maxilla and mandible is thus reestablished, starting from the present, pathological actual situation. Backward planning thus permits a precise final supply with denture made of high-quality materials.

The entire workflow starting from the data of dental arches in occlusion of the maxilla and mandible in a dental arch database results as a digital image of the milling blanks with the dental arches, via a matching of the digitally acquired impression of the patient situation with the aid of a maxilla/mandible relation in occlusion as much as possible by, for example, the BD-KEY, old prosthesis, or conventional impression, via existing CAD/CAM methods in the production of, for example, partial or total prostheses.

Matching is the digital way in that the virtual models are virtually plaster cast directly with the also scanned surfaces of the jaw registration.

An individual supply for almost every patient by means of digital workflows is ensured by means of a digital dental arch database with tooth positions in occlusion, which are on the basis of the individualization of the tooth position in occlusion.

The method is preferably carried out on the basis of a digital impression by means of an intraoral scanner, for example, by use of the Baltic Denture System®, which consists of a BD-KEY set. The BD-KEY set consists, for example, of an occlusal registration tool for the mandible and an occlusal registration tool for the maxilla, wherein the occlusal registration tool for the maxilla and mandible has teeth already in occlusion. This is inserted into the mouth of the patient. The occlusal registration tool for the maxilla can be fixedly connected via an encryption element to the occlusal registration tool for the mandible. The data are thereupon scanned by an intraoral scanner and transferred into software provided for this purpose, for example CAD software for the design. The data of dental arches in occlusion are thus digitized and saved and stored in a dental arch database. Individualized impression trays also suitable as individual impression trays, and/or individualized tooth restorations can thus be produced subtractively or additively by the transfer of the data by a CAM method, for example.

The advantage is that the entire impression and digitization of the data can take place in only one session. The data are thereupon directly transferred to a dental laboratory and the finished design can be carried out digitally there in a further session. Due to the digital positioning of the dental arches in occlusion, any subsequent fitting and assignment of the jaws in relation to one another is dispensed with.

The advantageous embodiment of the present invention is described on the basis of the following drawing.

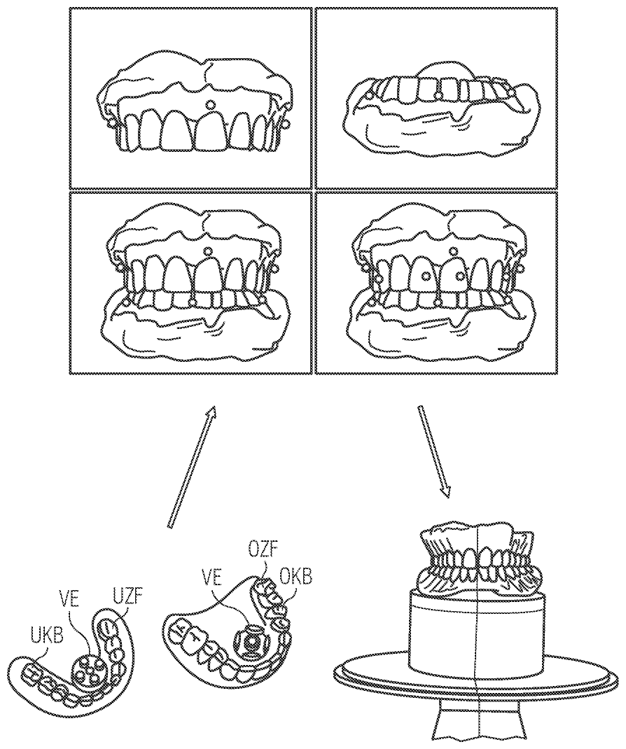

FIG. 1 shows an occlusal registration tool for the maxilla and mandible, the dental arch database, and a finished total prosthesis.

FIG. 1 shows data of dental arches 1, 2 positioned in occlusion in CAD software, which are provided in a dental arch database 10. The data of dental arches 1, 2 are predefined on the basis of a scanned data set of the mouth situation of the patient. The data of maxilla and mandible dental arches in occlusion are positioned in a predefined situation-related position. The mouth situation of the patient or the jaw relation of the patient is determined by means of the occlusal registration tool for the maxilla and mandible, wherein the occlusal registration tool has dental arches already positioned in occlusion. The occlusal registration tool of the maxilla can be fixedly connected via an encryption element to the occlusal registration tool of the mandible. The occlusal registration tool of the maxilla and mandible can also be inserted by means of a connecting element in the mouth of the patient. For example, a total prosthesis as shown in FIG. 1 is produced on the basis of the digitally predefined data of dental arches of the maxilla and mandible, which are already positioned in occlusion. It can be seen clearly in FIG. 1 that the artificial teeth of the prosthesis of the maxilla and mandible are in an exact relation to one another, so that the prosthesis no longer has to be finished or the positioning of the occlusion by means of an aid, for example an articulator, is no longer necessary. This saves work effort on the part of the dental technician and the dentist and possibly saves further sessions for the patient.

It has proven to be advantageous if the digital data of dental arches positioned in occlusion correspond due to the method for occlusal registration and the use of an occlusal registration tool, as described in German patent application DE 10 2014 117 252, the content of the disclosure of which is incorporated in its entirety in the present content of the disclosure. This is also the case when the workpiece for producing a denture by data of maxilla and mandible dental arches in occlusion at least partially corresponds to the tooth shapes of a milling block also arrayed in the occlusion position, preferably a dental milling block, as described in German patent application DE 10 2011 118 320, the content of the disclosure of which, preferably with regard to the milling block, the milling block system, and corresponding production method, is incorporated in its entirety in the present content of the disclosure.

1. A method for producing a denture, comprising:
a) providing a predefined digital dental arch database, wherein the dental arch database has data of maxilla and mandible dental arches in occlusion; and
b) generating the denture on the basis of the data of maxilla and mandible dental arches in occlusion.

2. The method of claim 1, wherein the data of maxilla and mandible dental arches in occlusion are positioned in a situation-related position.

3. The method of claim 2, wherein the situation-related position is predefined.

4. The method of claim 3, wherein the predefined situation-related position is provided by the predefined data of maxilla and mandible dental arches in occlusion.

5. The method of claim 1, wherein an adaptation of individual teeth from the dental arch database can take place individually.

6. The method of claim 1, wherein a digital design and a manufacture of a restoration by means of subtractive and/or additive production methods are carried out by the predefined situation-related position.

7. The method of claim 1, wherein one or more implant connecting elements are digitally positioned and designed in the maxilla and mandible on the basis of the predefined data of maxilla and mandible dental arches in occlusion.

8. The method of claim 1, wherein the tooth shape and/or tooth size and/or tooth color and/or tooth arch width of the predefined digital data of maxilla and mandible dental arches in occlusion can be adapted to scanned data of a mouth situation of a patient.

9. A workpiece for producing a denture, characterized by data of maxilla and mandible dental arches in occlusion, which are provided digitally in a dental arch database.

10. A method, comprising the use of a digital dental arch database having data of maxilla and mandible dental arches in occlusion for producing a partial or total prosthesis.

11. The method of claim 10, wherein the use comprises producing a denture according to the method of claim 1.

12. A method, comprising the use of a digital dental arch database having data of maxilla and mandible dental arches in occlusion for producing an occlusal registration tool.

13. The method of claim 12, wherein the use comprises providing the predefined digital dental arch database, wherein the dental arch database has data of maxilla and mandible dental arches in occlusion; and generating the occlusal registration tool on the basis of the data of maxilla and mandible dental arches in occlusion.
